(19) United States
(12) Patent Application Publication
(10) Pub. No.: US 2005/0269011 A1
(43) Pub. Date: Dec. 8, 2005

(54) Methods of making spunbonded fabrics from blends of polyarylene sulfide and a crystallinity enhancer

(75) Inventors: Andrew Auerbach, Livingston, NJ (US); Martin Brueck, Weilrod (DE); Ramesh Srinivasan, Simpsonville, SC (US)

Correspondence Address: NIXON & VANDERHYE, PC, 901 NORTH GLEBE ROAD, 11TH FLOOR, ARLINGTON, VA, 22203, US

(73) Assignee: Ticona LLC, Summit, NJ (US)

(21) Appl. No.: 10/858,392

(22) Filed: Jun. 2, 2004

(51) Int. Cl. D04H 3/16; B32B 5/26; D04H 3/00; B27N 3/00

(52) U.S. Cl. 156/62.6; 442/414; 442/401; 442/364; 442/382; 264/103; 264/211.12

(57) ABSTRACT

Spunbonded fabrics are formed by melt-spinning a blend comprised of a major amount of an uncured substantially amorphous polyarylene sulfide and a minor amount of a crystallinity enhancer to obtain a nonwoven mass of filaments, and thereafter passing the nonwoven mass of filaments through a nip of heated calendering rolls to form a spunbonded fabric therefrom having at last substantially crystalline surface regions. Preferably, blending minor amounts of a polyolefin (e.g., polypropylene) with an uncured polyarylene sulfide (e.g., polyphenylene sulfide) allows spunbonded nonwoven fabrics to be formed which do not suffer from the drawbacks noted above. More specifically, spunbonded fabrics formed of a blend of PPS and polypropylene may be calendered (bonded) at temperatures greater than between about 110 to about 125° C. (preferably greater than about 140° C.), and exhibit lengthwise and widthwise shrinkage after heatsetting at 120° C. for 3 minutes which is less than about 5%.

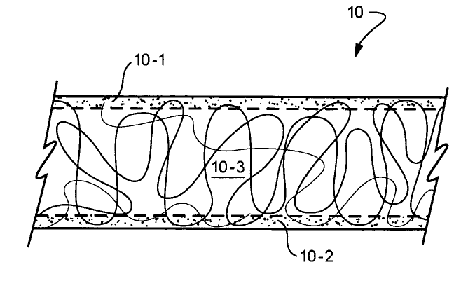

### FIELD OF THE INVENTION

The present invention relates generally to methods of making spunbonded fabrics and to methods of making the same. In especially preferred embodiments, the present invention relates to methods of making spunbonded fabrics by use of a blend of a polyarylene (e.g., a polyphenylene sulfide (PPS)) and a crystallinity enhancer (e.g., a polyolefin).

### BACKGROUND AND SUMMARY OF THE INVENTION

Spunbonded non-woven fabrics formed from thermoplastic polymeric materials are well known. In this regard, a thermoplastic polymer is typically melted in an extruder and extruded through a dense plurality of filament-forming orifices associated with a spinneret to form a corresponding dense plurality of extruded polymer streams. The polymer streams are cooled and solidified prior to being collected as an incoherent web on a moving collection screen. The web is then passed into and through the nip of a pair of heated bonding calender rolls which operate at a sufficiently high temperature to cause filament-to-filament bonding and thereby form a coherent and structurally self-supporting spunbonded fabric.

Nonwoven structures have also been formed by means of melt blown techniques. According to conventional melt-blown processes, a thermoplastic polymer is melt-extruded through a series of orifices to form a corresponding series of molten polymer streams as is similar to conventional spunbonding techniques. However, instead of being quenched with ambient cooling air, the polymer streams are contacted with heated air so as to maintain the streams in a molten state and attenuate the same as they progress toward a collection surface. Thus, upon reaching the collection surface, the melt-blown filaments are still molten thereby causing the filaments to coalesce with one another at their crossing points and thereby bond one to another upon cooling.

Recently, U.S. Pat. Nos. 6,110,589 and 6,130,292 (the entirety of each being expressly incorporated hereinto by reference) disclose that incorporating a small amount of a polyolefin in a polyarylene sulfide resin, such as cured or semi-cured polyphenylene sulfide (PPS), serves as a lubricant of sorts so as to enhance the melt-blowing process by preventing or delaying the build up of the polyarylene sulfide resin on the internal parts and the extrusion orifices.

The ability to form spunbonded fabrics from PPS resins is attractive for a number of technical reasons owing to the chemical and thermal heat resistance of the PPS resin itself. However, contrary to melt-blowing processes (which form a coherent fused mass of non-woven filaments on a collection surface by virtue of their being collected in a molten or near molten state), the spunbonding process necessarily entails subjecting an incoherent (unbonded) mass of solidified nonwoven filaments to thermal bonding by passing the web through a nip of a pair of heated bonding calender rolls. It is difficult to calender spunbonded fabrics of PPS, however, at sufficiently high bonding temperature (e.g., greater than about 125° C.) due to the relatively amorphous nature of the PPS which causes the fabric to stick to the calender rolls. Moreover, nonwoven fabrics formed of PPS suffer from excessive shrinkage during heat setting. As such, spunbonded PPS nonwoven fabrics have not to date become a commercial reality.

It has now been discovered that blending minor amounts of a polymeric crystallinity enhancer (e.g., polypropylene) with substantially amorphous uncured polyarylene sulfide (e.g., polyphenylene sulfide) allows spunbonded nonwoven fabrics to be formed which do not suffer from the drawbacks noted above. Specifically, spunbonded fabrics formed of a blend of PPS and polypropylene may be calendered (bonded) at temperatures greater than between about 110° C. (e.g., greater than about 125° C., and preferably greater than about 140° C.), and exhibit lengthwise and widthwise shrinkage after heatsetting at 120° C. for 3 minutes which is less than about 5%.

These and other aspects and advantages will become more apparent after careful consideration is given to the following detailed description of the preferred exemplary embodiments thereof.

### BRIEF DESCRIPTION OF THE ACCOMPANYING DRAWINGS

Reference will hereinafter be made to the accompanying drawing FIGURE which is a schematic cross-sectional representation of a spunbonded nonwoven fabric which embodies the present invention.

### DETAILED DESCRIPTION OF THE INVENTION

A. Definitions

The terms identified below are intended to have the following definitions throughout the specification and claims:

“Substantially amorphous” means that the crystallinity of the polymer is 60% or less, usually 50% or less, of the maximum crystallinity that can be achieved for that polymer. Conversely, the term “substantially crystalline” means that the crystallinity of the polymer is 60% or greater, usually 75% or greater, of the maximum crystallinity that can be achieved for that polymer.

“Uncured polyarylene sulfide” means polyarylene sulfide which has a linear (i.e., unbranched) molecular structure.

“Filament” and “filamentary” each means a fibrous strand of extreme or indefinite length.

“Fiber” means a fibrous strand of definite length, such as a staple fiber.

“Nonwoven” means a collection of filaments and/or fibers which are randomly arranged and mechanically interlocked with respect to one another in a sheet-like web or mat structure to form a fabric.

B. Description of Preferred Embodiments

Virtually any uncured polyarylene sulfide may be employed satisfactorily in the practice of the present invention. In this regard, polyarylene sulfides are well known in the art and are described, for example, in U.S. Pat. Nos. 3,354,127, 4,645,826 and 5,824,767 (the entire content of each being expressly incorporated hereinto by reference). In general, the polyarylene sulfides employed in the practice of the present invention are those prepared by the reaction of an alkali metal sulfide and a dihalo-aromatic compound. Depending upon the particular method of preparation, the polyarylene sulfide may exist as random or block homopolymers or copolymers.

Suitable alkali metal sulfides that may be employed include lithium sulfide, sodium sulfide, potassium sulfide, rubidium sulfide, cesium sulfide and mixtures thereof. The alkali metal sulfides may be used as hydrates or aqueous mixtures, or in anhydrous forms. Sodium sulfide is preferred due to its relatively lower cost.

Suitable dihalo-aromatic compounds include p-dichlorobenzene, m-dichlorobenzene, 2,5-dichlorotoluene, 2,5-dichloro-p-xylene, p-dibromobenzene, 1,4-dichloronaphthalene, 1-methoxy-2,5-dichlorobenzene, 4,4′-dichlorobiphenyl, 3,5-dichlorobenzoic acid, p,p′-dichlorodiphenylsulfoxide, p,p′-dichlorodiphenylketone, and the like. Especially preferred are those composed mainly of para-dihalobenzene, typically, p-dichlorobenzene.

Most preferably, the polyarylene sulfide is uncured polyphenylene sulfide (PPS) having a melt viscosity (MV) determined at 310° C. and a shear rate at 1200 sec⁻¹ of between about 200 to about 6,000 poise, and most preferably between about 1200 to about 3000 poise. An especially preferred PPS that may be employed in the practice of this invention will have a MV of about 2400 poise, and is commercially available from Ticona LLC as FORTRON® 0320 polyphenylene sulfide.

In accordance with the present invention, a major amount of uncured polyarylene sulfide will necessarily be melt blended with a crystallinity enhancing effective amount of a crystallinity enhancer. In this regard, the preferred crystallinity enhancer that may be employed in the practice of the present invention include melt-spinnable polyolefins, such as polyethylene, polypropylene, polybutylene and polyoctene, polyalkylene terephthalates, such as polybutylene terephthalate (PBT), polyethylene terephthalate (PET), polycyclohexylene dimethylene terephthalate (PCT) and polyethylene naphthalate (PEN), and polyamides, such as nylon 6, nylon 6,6 and other high temperature polyamides.

Preferred high temperature polyamides include those polyamides that have from 20 to 78 wt. % of any polyamide that has a melting point of from 280° C. to about 340° C. An example of a suitable polyamide is a copolyamide composed of 20-80 mole % of units derived from hexamethylene terephthalamide and 80-20 mole % of units derived from hexamethylene adipamide. Other suitable polyamides include polyamide composed of 20-80 mole % of units derived from hexamethylene terephthalamide and 80-20 mole % of units derived from hexamethylene sebacamide, hexamethylene dodecamide, hexamethylene isophthalamide, 2-methylpentamethylene terephthalamide, or mixtures thereof. Other suitable polyamides are those characterized as crystallizable or semi-crystallizable partially aromatic polyamides of fast or intermediate crystallization rate as described more fully in U.S. Pat. No. 6,207,745, the entire content of which is expressly incorporated hereinto by reference.

Presently preferred for use in the present invention is melt-spinnable polypropylene. The preferred polypropylene (PP) resin that may be employed in the practice of the present invention will have a melt flow rate (MFR) of between about 2 to about 1600 g/10 minutes, and most preferably between about 400 to about 1200 g/10 minutes. An especially preferred PP that may be employed in the practice of this invention will have a MFR of about 800 g/10 minutes, and is commercially available from numerous commercial sources (e.g., Basell, ExxonMobil, BP Amoco and the like).

The amount of filamentary crystallinity enhancer will be melt-blended with the polyarylene sulfide in relatively minor amounts of between about 1 to about 10 wt. %, preferably between about 3 to about 7 wt. % and advantageously about 5 wt. %.

Any conventional spunbonding technique may be employed in the practice of this invention. For example, a dry master blend of chips formed of each of the polyarylene sulfide and the crystallinity enhancer may be introduced into the hopper of a conventional extruder and extruded through appropriately sized orifice holes associated with a spinneret. Alternately, the desired amounts of polyphenylene sulfide and crystallinity enhancer may be blended in a melt phase, resolidified and pelletized. The extruded filament streams are cooled and solidified as they proceed on to a collection surface by ambient air to form an incoherent web of the collected filaments. The web is then passed to and through the nip of a pair of heated calender rollers wherein the filaments are bonded one to another by virtue of the heat and pressure thereof.

The filaments which are melt-spun may be formed entirely of the blend of polyphenylene sulfide and crystallinity enhancer. Alternatively or additionally, the blend of polyphenylene sulfide and crystallinity enhancer may be co-melt spun with another polymeric component to form a bicomponent filament wherein the blend of the polyarylene sulfide/crystallinity enhancer is the sheath of a sheath-core bicomponent filament, with the other polymeric component occupying the core thereof. In such a manner, various physical properties may be “engineered” into the resulting non-woven spunbonded fabrics of the present invention. The core polymeric component may be any melt-spinnable thermoplastic polymer which is compatible with the blend of polyarylene sulfide and polymeric crystallinity enhancer, such as, for example, polyolefins (e.g., polyethylene, polypropylene, polybutylene, polyoctene and the like), polyamides (e.g., nylons such as nylon 6, nylon 6,6, nylon 6,12 and like high temperature nylons as describe previously), and polyalkylene terephthalates (e.g., PBT, PET, PCT, PEN and the like).

The average filament diameter of the spun-bonded filaments employed in the practice of the present invention can vary in dependence upon the desired properties of the spunbonded nonwoven fabric. For example, average filament diameters of between about 15 to about 30 μm, and usually between about 20 to about 25 μm.

The heated calender rolls most preferably are provided with a patterned land surface which allows for at least about 15% or more of contact area between the lands of the roller and the surface of the nonwoven fabric.

A schematic cross-sectional view of a non-woven fabric 10 which embodies the present invention is depicted generally in the accompanying drawing FIGURE. As shown, the fabric 10 is comprised of a mass of randomly intermingled filaments comprised of a polymer blend of polyphenylene sulfide and a crystallinity enhancer as described above which has been subjected to calendering between a pair of heated calender rolls so as to achieve surface regions 10-1 and 10-2 which exhibit higher crystallinity as compared to the crystallinity of the polymer blend prior to calendering. In this regard, it is preferred that the filaments within the surface regions 10-1 and 10-2 exhibit substantial crystallinity of at least about 60%, and more preferably at least about 75% or more. Advantageously, the filaments within at least one, and preferably both, of the surface regions 10-1 and 10-2 exhibit a crystallinity of substantially 100%. While at least the surface regions 10-1 and 10-2 have a crystallinity of substantially 100%, the core region 10-3 of the fabric could likewise exhibit a crystallinity of substantially 100% if subjected to calendering under the appropriate conditions and/or using appropriately configured calender rolls. Typically, however, the core region 10-3 of the fabric 10 will be substantially amorphous. Thus, even though the surface regions 10-1, 10-2 exhibit substantially 100% crystallinity, the overall crystallinity of the entire fabric 10 across its thickness can be less than about 60%. In such a situation, however, the fabric 10 would still be within the scope of this invention.

The fabric 10 depicted in the accompanying drawing FIGURE may be used “as is” or may be laminated with one or more other sheet-like structures so as to achieve the desired end product. The other sheet-like structures to which the fabric 10 may be laminated may themselves be a nonwoven fabric, but other woven and/or knitted fabrics may also be employed. Lamination of the spunbonded fabric with at least one other sheet-like product may be accomplished in-line downstream of the calender rolls

The present invention will be further understood by reference to the following non-limiting Examples.

### EXAMPLES

### Example I

A blend 95/5 wt. % PPS (FORTRON® 0320) and PP (MFR 35), respectively, was spunbonded into a fabric by passing a melt of the PPS/PP blend through a spinneret supplied with ambient quench air to obtain attenuated filaments which were collected as an incoherent web on a moving conveyor belt. The collected web of filaments were then bonded to one another to form a spunbonded fabric by passing the web through the nip of heated bonding calender rolls operating at a temperature of about 140° C. The spunbonded fabric was subject to heat setting at a elevated temperature (120° C./3 minutes) and fabric shrinkage before and after such heat setting was measured in both the lengthwise and widthwise fabric directions. The data obtained from this example appears as E1 in Table 1 below.

### Comparative Examples II and III

For comparison, Example I was repeated using 100% PPS. In order to avoid sticking of the fabric onto the bonding calender rolls, the bonding temperature of the rolls had to be maintained at less than 110° C. Comparative Example The data of these examples appears in Table 1 below as CE1 and CE2, respectively.

TABLE I

| | | | | | | | Mean |
|---|---|---|---|---|---|---|---|
| | PPS | PP | % shrink | % shrink | % crystallinity | % crystallinity | Fiber |
| | wt. % | wt. % | length | width | (as produced) | (after heat set) | Dia. (μm) |
| E1 | 95 | 5 | 4.5 | 4.3 | 45.4 | 61.5 | 21.7 |
| CE1 | 100 | — | 40.9 | 48.2 | 46.8 | 51.9 | 13.9 |
| CE2 | 100 | — | 19.3 | 23.8 | 46.0 | 48.2 | 13.6 |

The addition of a relatively minor amount (i.e., 5 wt. %) of PP to PPS as in fabric E1 allowed the bonding calender rolls to be operated at a higher temperature without sticking as compared to both the fabrics CE1 and CE2. In addition, it was found that the spunbonded fabric comprised of a blend of PPS and PP had dramatically less shrinkage than either of the comparative fabrics formed entirely of spunbonded PPS filaments. The crystallinity of the initial fabric after calendering was similar between he PPS and the PPS/PP blend. The PPS/PP blend fabric of CE1 exhibited an increase in the crystallinity after heat setting (e.g., 61.5 vs. 45.4) which may have accounted for some part of the reduced fabric shrinkage that was observed. The crystallinity measurement is made on the entire nonwoven spunbonded fabric thickness. The outer layers of the fabric in contact with the calender rolls exhibits 100% crystallization after treatment. The high crystallinity of the outer layer is therefore believed to explain the exceptionally good shrinkage of the PPS/PP blend sample that was calendered at 120° C.

The data obtained therefore demonstrates that blends of PPS and PP are beneficial in allowing higher bonding calendaring temperatures to be practiced while at the same time minimizing fabric shrinkage.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method of making a spunbonded fabric comprising (i) melt-spinning a blend comprised of a major amount of an uncured substantially amorphous polyarylene sulfide and a minor amount of a polymeric crystallinity enhancer to obtain a nonwoven mass of filaments, and thereafter (ii) passing the nonwoven mass of filaments through a nip of heated calendering rolls to form a spunbonded fabric therefrom having at least substantially crystalline surface regions.

2. The method as in claim 1, wherein the polyarylene sulfide is a reaction product of an alkali metal sulfide and a dihalo-aromatic compound.

3. The method as in claim 2, wherein the crystallinity enhancer is at least one polymer selected from the group consisting of polyolefins, polyalkylene terephthalates, and polyamides.

4. The method as in claim 3, wherein the crystallinity enhancer is a polyolefin selected from polyethylene, polypropylene, polybutylene and polyoctene.

5. The method of claim 3, wherein the crystallinity enhancer is a polyalkylene terephthalate selected from polybutylene terephthalate (PBT), polyethylene terephthalate (PET), polycyclohexylene dimethylene terephthalate (PCT) and polyethylene naphthalate (PEN).

6. The method of claim 3, wherein the crystallinity enhancer is a polyamide selected from nylon 6 or nylon 6,6.

7. The method of claim 3, wherein the crystallinity enhancer is a high temperature polyamide having a melting point from about 280° C. to about 340° C.

8. The method of claim 7, wherein the high temperature polyamide is a copolyamide comprised of 20-80 mole % of units derived from hexamethylene terephthalamide and 80-20 mole % of units derived from at least one of hexamethylene adipamide, hexamethylene sebacamide, hexamethylene dodecamide, hexamethylene isophthalamide, 2-methylpentamethylene terephthalamide and mixtures thereof.

9. The method of claim 1, wherein step (ii) is practiced so that said substantially crystalline surface regions exhibit a crystallinity of at least 60%.

10. The method of claim 9, wherein said substantially crystalline surface regions exhibit a crystallinity of at least about 70%.

11. The method of claim 9, wherein said substantially crystalline surface regions exhibit a crystallinity of about 100%.

12. The method of claim 1, which further comprising laminating said spunbonded fabric to at least one other sheet-like product.

13. The method of claim 1, wherein step (i) is practiced by co-melt spinning the blend of amorphous polyarylene sulfide and crystallinity enhancer as a sheath component with a core component formed of another melt-spinnable thermoplastic polymer.

14. A method of making a spunbonded fabric comprising the steps of:
(a) melt-extruding a thermoplastic blend consisting essentially of an uncured polyphenylene sulfide (PPS) and polypropylene (PP) through a plurality of spinneret orifices to form a corresponding plurality of molten filamentary streams;
(b) directing the molten filamentary streams issuing from the spinneret orifices toward a collection surface and allowing the filamentary streams to solidify as they travel toward the collection surface and thereby form solidified filaments of said thermoplastic blend;
(c) collecting the solidified filaments on the collection surface as an incoherent nonwoven mass; and thereafter
(d) passing the incoherent mass through the nip of a pair of heated calendering rolls so as to bond the solidified fibers one to another and form a coherent fabric thereof.

15. The method of claim 14, wherein step (d) is practiced at a calendering temperature of about 125° C. or greater.

16. The method of claim 15, wherein the calendering temperature is about 140° C.

17. The method of claim 14, wherein the thermoplastic blend consists essentially of between about 1 to about 10 wt. % of PP.

18. The method of claim 17, wherein the thermoplastic blend consists essentially of between about 3 to about 7 wt. % of PP.

19. The method of claim 18, wherein the thermoplastic blend consists essentially of about 5 wt. % of PP.

20. The method of claim 14, wherein the PPS has a melt flow rate of between about 2 g/10 minutes to about 1600 g/10 minutes.

21. The method of claim 20, wherein the PP has a melt flow rate of between about 400 g/10 minutes to about 1200 g/10 minutes.

22. A spunbonded fabric made according to any one of claims 1-21.

23. The spunbonded fabric as in claim 22, having lengthwise and widthwise shrinkage values after heatsetting at 120° C. for 3 minutes of less than about 5%.

24. A spunbonded fabric comprised of a mass of nonwoven filaments which comprise a blend of a major amount of an uncured substantially amorphous polyarylene sulfide and a minor amount of a polymeric crystallinity enhancer, wherein said filaments are substantially crystalline at least at a surface region of said fabric.

25. The spunbonded fabric as in claim 24, wherein the polyarylene sulfide is a reaction product of an alkali metal sulfide and a dihalo-aromatic compound.

26. The spunbonded fabric as in claim 25, wherein the crystallinity enhancer is at least one polymer selected from the group consisting of polyolefins, polyalkylene terephthalates, and polyamides.

27. The spunbonded fabric as in claim 26, wherein the crystallinity enhancer is a polyolefin selected from polyethylene, polypropylene, polybutylene and polyoctene.

28. The spunbonded fabric of claim 26, the crystallinity enhancer is a polyalkylene terephthalate selected from polybutylene terephthalate (PBT), polyethylene terephthalate (PET), polycyclohexylene dimethylene terephthalate (PCT) and polyethylene naphthalate (PEN).

29. The method of claim 24, wherein the crystallinity enhancer is a polyamide selected from nylon 6 or nylon 6,6.

30. The method of claim 24, wherein the crystallinity enhancer is a high temperature polyamide having a melting point from about 280° C. to about 340° C.

31. The method of claim 30, wherein the high temperature polyamide is a copolyamide comprised of 20-80 mole % of units derived from hexamethylene terephthalamide and 80-20 mole % of units derived from at least one of hexamethylene adipamide, hexamethylene sebacamide, hexamethylene dodecamide, hexamethylene isophthalamide, 2-methylpentamethylene terephthalamide and mixtures thereof.

32. The spunbonded fabric of claim 24, wherein said filaments at a surface region thereof exhibit a crystallinity of at least 60%.

33. The spunbonded fabric of claim 32, wherein said filaments at a surface region thereof exhibit a crystallinity of at least 70%.

34. The spunbonded fabric of claim 32, wherein said filaments at a surface region thereof exhibit a crystallinity of about 100%.

35. The spunbonded fabric of claim 24, which further comprises at least one other sheet-like product laminated to said spunbonded fabric.

36. The spunbonded fabric of claim 24, wherein said filaments are sheath-core bicomponent filaments having said blend of amorphous polyarylene sulfide and crystallinity enhancer as a sheath component, and another melt-spinnable thermoplastic polymer as a core component.
